(19) United States
(12) Patent Application Publication
(10) Pub. No.: US 2005/0216131 A1
(43) Pub. Date: Sep. 29, 2005

(54) Residential load power management system

(76) Inventors: Wesley C. Sodemann, Dousman, WI (US); Kenny J. Stair, North Prairie, WI (US); Philip Gull, New Berlin, WI (US)

Correspondence Address: MICHAEL BEST & FRIEDRICH, LLP, 100 E WISCONSIN AVENUE, MILWAUKEE, WI, 53202, US

(21) Appl. No.: 11/086,167

(22) Filed: Mar. 22, 2005

Related U.S. Application Data
(60) Provisional application No. 60/555,840, filed on Mar. 24, 2004.

(51) Int. Cl. G05D 11/00

(52) U.S. Cl. 700/295

(57) ABSTRACT

A load management system for residential use is disclosed. The system includes a first signal-responsive switch connected to a first load, and a second signal-responsive switch connected to a second load that has a lower priority than the first load. The system also includes a sensor to sense first and second electrical signals associated with the respective first and second loads. The system also includes a controller to ensure that the second signal-responsive switch is in an OPEN state after the sensor senses that the first electrical signal exceeds a first threshold value, and that the first signal-responsive switch is in a CLOSED state after the first electrical signal exceeds a second threshold value.

### RELATED APPLICATION

This application claims the benefit of provisional application No. 60/555,840 filed on Mar. 24, 2004.

### BACKGROUND OF THE INVENTION

The present invention relates to power distribution, and more particularly, to residential power distribution system.

During a power outage in a residence, if a secondary power source or a back up power source such as a standby generator has been installed, the secondary power source will normally be turned on either manually or automatically to provide a limited amount of power to the residence. The amount of power provided to the residence depends on ratings of the secondary power source. For example, a generator with a low power rating can provide a relatively lower amount of power or amperage. As a result, only limited power is provided to selected electrical loads. In some situations, the amount of power also limits the types of loads to be operated. For example, when large appliances such as air conditioners and water heaters are operating, smaller on-demand appliances such as microwave ovens and toasters cannot be used due to running a risk of overloading the secondary power source.

Standby back up generators are also known. However, standby back up generators with low power ratings can still be overloaded when more power is demanded than can be supplied by the generators. Furthermore, standby back up generators with high power ratings are much more costly.

### SUMMARY OF THE INVENTION

The invention provides a load management system for managing a plurality of loads in a residence. The load management system includes at least one current transformer configured to monitor the current input from a standby generator. The load management system also includes a plurality of fuel type switches and generator rating switches. The fuel type switches allow a user or an installer to select a fuel type at installation that is used by the generator. Similarly, the generator rating switches allow the operator to select a generator output rating at installation. The load management system also includes a plurality of prioritized relays preferably having the same power ratings. Settings of the switches and relay priorities are fixed at installation by the operator or installer. Having the same power ratings for all relays simplifies the installation process. The operator or installer therefore just needs to decide the priority of each load in the residence. The load management system also allows expansion by providing an expansion slot. In this way, more loads in the residence can be controlled and managed.

In one form, the invention provides a load management system for residential use. The system includes a first signal-responsive switch connected to a first load, and a second signal-responsive switch connected to a second load that is smaller than the first load. The system also includes a sensor to sense first and second electrical signals from the respective first and second loads. The system also includes a controller to ensure that the second signal-responsive switch is in an OPEN state after the sensor senses that the first electrical signal exceeds a first threshold value, and that the first signal-responsive switch is in a CLOSED state after the first electrical signal exceeds a second threshold value. The controller determines whether the first and second signal-responsive switches are in their desired states, and if not, the controller activates the switches to place them in their desired states.

In another form, the invention provides a method of managing loads for residential use. The method includes connecting a first signal-responsive switch and a second signal-responsive switch to a first load and a second load, respectively. The second load is smaller than the first load. The method also includes sensing first and second electrical signals from the respective first and second loads. The method also includes ensuring the second signal-responsive switch is in an OPEN state after the first electrical signal exceeds a first threshold value, and the first signal-responsive switch is in a CLOSED state after the first electrical signal exceeds a second threshold value. The controller determines whether the first and second signal-responsive switches are in their desired states and, if not, the controller activates the switches to place them in their desired states.

Other features and advantages of the invention will become apparent to those skilled in the art upon review of the following detailed description, and drawings.

### BRIEF DESCRIPTION OF THE DRAWINGS

FIG. 1 illustrates a residential electrical system having a load management system according to an embodiment of the invention.

FIG. 2 is a system block diagram of the load management system shown in FIG. 1 embodying the invention.

FIG. 3 is a fuel power table for the load management system shown in FIG. 1.

FIG. 4 shows a relay structure of the load management system shown in FIG. 1.

FIG. 4A shows a second relay structure of the load management system shown in FIG. 1.

FIG. 5 is an appliance priority table for the load management system shown in FIG. 1.

FIG. 6 is a flow chart of a load management process according to an embodiment of the invention.

FIG. 7 is a second flow chart of an exemplary load control subroutine.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. In addition, the terms “connected” and “coupled” and variations thereof are not restricted to physical or mechanical connections or couplings.

As should also be apparent to one of ordinary skill in the art, the systems shown in the figures are models of what actual systems might be like. As noted, many of the modules and logical structures described are capable of being implemented in software executed by a microprocessor or a similar device or of being implemented in hardware using a variety of components including, for example, application specific integrated circuits (“ASICs”). Terms like “processor” may include or refer to both hardware and/or software. Furthermore, throughout the specification capitalized terms are used. Such terms are used to conform to common practices and to help correlate the description with the coding examples, equations and/or drawings. However, no specific meaning is implied or should be inferred simply due to the use of capitalization. Thus, the claims should not be limited to the specific examples or terminology or to any specific hardware or software implementation or combination of software or hardware.

Embodiments of the invention relate to a method and system for managing some residential loads. In one embodiment, when one of the residential loads demands power from a generator, the system determines if the power output capacity of the generator is sufficient to be supplied to all the loads connected to the generator. The system proceeds to shed some residential loads when the generated power is insufficient to power all the loads connected to the generated.

In a specific embodiment, a load management system includes a sensor to sense first and second electrical signals from first and second loads, respectively. A controller also ensures that the second signal-responsive switch is in an OPEN state after the sensor senses that the first electrical signal exceeds a first threshold value, and that the first signal-responsive switch is in a CLOSED state after the first electrical signal exceeds a second threshold value.

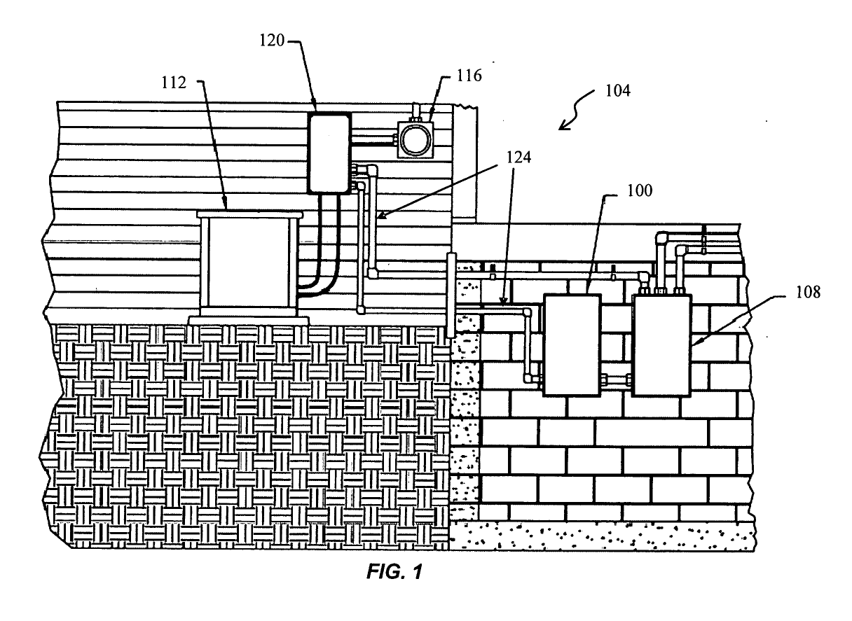

FIG. 1 shows a load management system 100 disposed in a residence 104 according to the invention. The load management system 100 is coupled to a load center or a circuit breaker 108. Power from such as a home standby generator 112 and a utility source 116 is connected to a transfer switch 120 outside of the residence 104. The transfer switch could be located inside the residence. The transfer switch 120 is also connected to the load management system 100 and the load center 108 via a plurality of conduits 124. The operation of the system is detailed hereinafter.

The load management system 100 manages a plurality of circuit protected loads (not shown). For example, the load management system 100 manages a total amount of current drawn from loads or appliances applied in the residence 104 such that the total current drawn is below some adjustable or programmable limits. Specifically, the transfer switch 120 generally has a dry contact available to send an activation signal to the load management system 100 to inform when the transfer switch 120 is on generator power. That is, when the generator 112 starts to supply power to the residence 104, the transfer switch 120 will generate an activation signal. In some embodiments, a current transformer is used to monitor the current supplied by the generator 112, detailed hereinafter. Once the load management system 100 senses the activation signal, the load management system 100 is activated. The load management system 100 could monitor the current from both the utility source 116 and the generator 112. Furthermore, the load management system 100 is generally housed in either a NEMA 1 or NEMA 3R enclosure. Although two types of enclosures are used, other enclosures that satisfy other technical requirements can also be used.

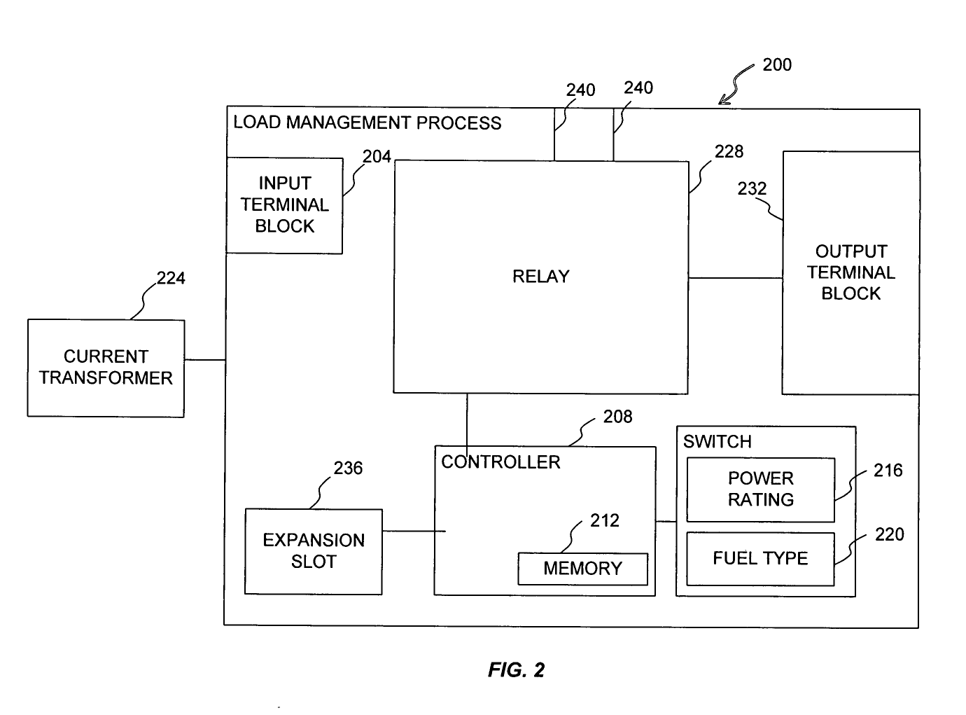

As shown in a system block diagram 200 in FIG. 2, the load management system 100 includes an input terminal block 204 to receive a plurality of incoming lines from the generator 112. A controller 208 monitors the incoming lines and manages the total current drawn or the generator loaded at or below a preset maximum amount, for example, 75 percent, of the rated load of the generator 112. In some embodiments, the preset maximum amount can also be set at 85 percent. In still some other embodiments, the preset maximum amount can be set at a number ranging from about 60 percent to about 95 percent. The controller 208 generally includes a memory 212 that stores the presets, among other things. The controller 208 also monitors a plurality of power-related switches such as a set of power rating switches or jumper 216, and a set of fuel type switches or jumpers 220. The power rating switches 216 allow an operator to switch between a plurality of generator output powers, for example, 10 Kilowatts (“KW”), 12 KW, 15 KW, or 17 KW. Of course, other generators with different output power can also be used. Similarly, the fuel type switches 220 allow the operator to select from a plurality of fuel types such as liquid propane (“LP”) and natural gas (“NG”) to be provided to the generator 112. Although LP and NG are listed as the fuel types that the operator is to select from, other fuel types such as gasoline, diesel, and the like can also be used, depending the fuel requirements of the generator 112. In this way, the operator has a flexibility of selecting a suitable combination of fuel type and generator 112.

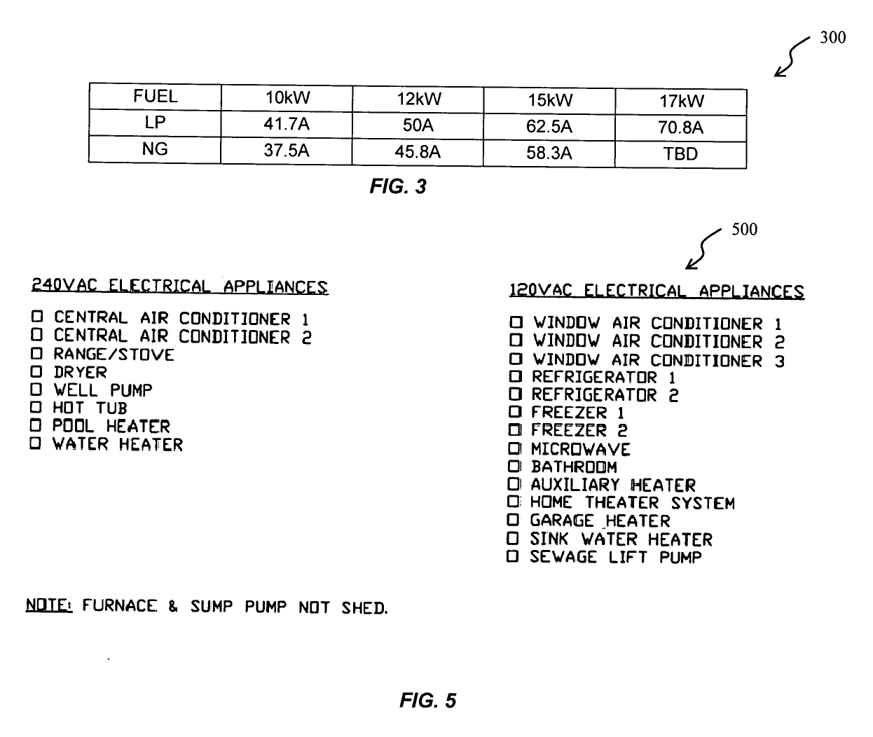

Depending on the fuel type, a generator 112 operates either at a rated wattage, or at a reduced wattage. In one embodiment, the generator 112 fueled by LP provides more power, wattage, or current than the same generator 112 fueled by NG. FIG. 3 shows a fuel power table 300 listing a plurality of current amounts generated by differently-rated generators fueled by different fuel types. The table 300 shows, for example, that a generator rated at 10 KW fueled by LP produces 41.7 A, which is 4.2 A more than the same generator but fueled by NG. The load management system 100 then monitors the incoming lines based on how the power-related switches 216 and the fuel type switches 220 are set.

Referring again back to FIG. 2, the load management system 100 is electrically connected to an external transforming block 224, having two current transformers in one embodiment. Although current transforming block 224 is shown as being external to load management system 100, the current transformers may be located in load center 108, in load management system 100, in transfer switch 120, or in a separate module, depending on whether both lines, generator power and/or the loads are monitored. The current transformers 224 typically have the same ratings. However, these transformers 224 can also have different ratings depending on design or user requirements. When the current transformers 224 on any line start to detect that the current drawn reaches a preset maximum amount of the rated load, the load management system 100 starts to operate, as detailed hereinafter.

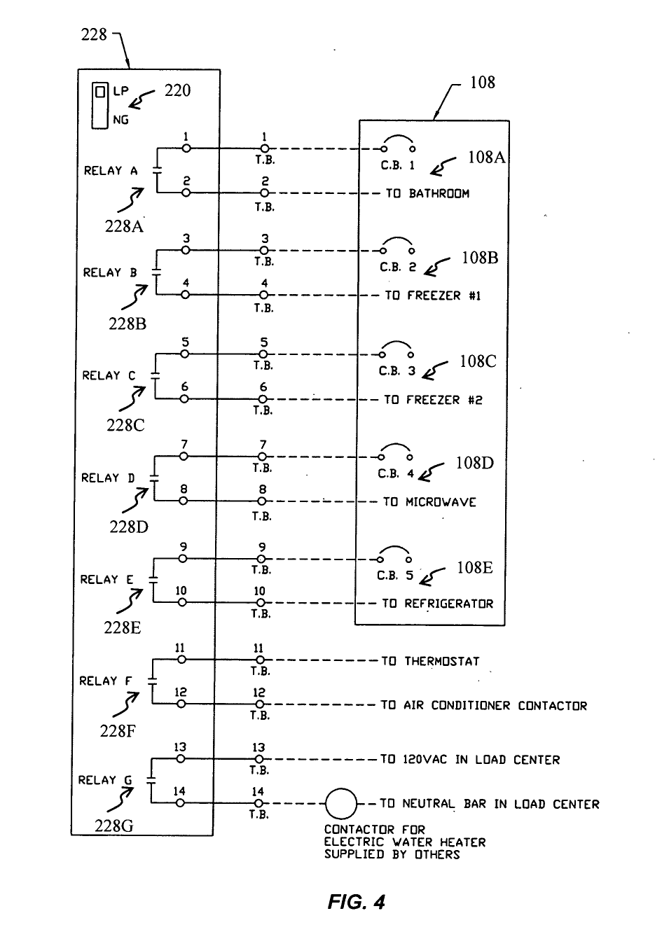

Furthermore, the load management system 100 includes a relay block 228 to relay power to an output terminal block 232. The relay block 228 has a bank of individually-labeled relays. As shown in FIG. 4, which shows one embodiment of the relay block 228 according to the invention, the relay block has seven relays (228A-228G). As shown in FIG. 4A, which shows a second embodiment of the relay block 228 according to the invention, the relay block has eight relays (228A1-228D2). For example, two of the eight relays (228A1 and 228A2) are assigned to have high priorities while the rest of the eight relays (228B1 to 228D2) are assigned to have low priorities regardless of the ratings of the respective loads. In some embodiments, the relays with higher priorities (228A1 and 228A2) are positioned on a low voltage board 229 which is coupled to a separate high voltage board 230 that houses the rest of the eight relays (228B1 to 228D2). Furthermore, in some embodiments, the relays can have any current ratings. These relays are typically rated at 120VAC and 20 A, although relays having other ratings can also be substituted. For example, if loads with the highest priorities are air-conditioning units, the corresponding relays can be rated at 24VAC and 1 A. The installer only needs to prioritize the loads coupled to the load management system 100, rather than matching a load with a plurality of priorities whose output powers are different. Generally, some loads are considered controlled loads, and therefore are managed by the load management system 100. As a result, some of the relays (228A-228G) are dedicated to the controlled loads. Typically, controlled loads include a refrigerator, water heater, washer and dryer, coffee maker, and the like. Other loads include low voltage loads such as air conditioners, and thermostats. In the embodiment shown in FIG. 4, some relays (228A-228E) are coupled to the output terminal block 232, which is further coupled to a plurality of circuit breakers (108A-108E) of the load center 108. Some of the relays are coupled to some dedicated appliances or loads such as the thermostat, and an air conditioner contactor, and some of the relays are coupled to the load center 108.

In one embodiment, the individually labeled relays (228A-228G) are prioritized based on the label on the relays. For example, a relay with a label A (228A) has a higher priority than any other relays (228B-228G). These priorities are generally fixed at installation. Therefore, when the total current drawn is above the preset maximum amount, the load coupled to the relay with label A (228A) is the last load to be shed, while the load coupled to the relay with label G (228G) is the first relay to be shed. Of course, other labels can also be used to indicate priorities.

After each shedding or after the total current drawn falls below the preset maximum amount, the loads are added in the same priority. That is, the load coupled to the relay with label A (228A) is the first load to add, while load coupled to the relay with label G (228G) is the last relay to add. For example, if relay A (228A) is coupled to a bathroom circuit, and relay G (228G) is coupled to a water heater circuit, power supplied to the water heater circuit will be disconnected first for a preset amount of time, and power supplied to the bathroom circuit is disconnected last but only when the total current drawn rises above the preset maximum amount. Similarly, when the total current drawn falls below a second preset amount after a shed, power supplied to the bathroom circuit is added first if the power is disconnected, and power supplied to the water heater will be added last. In some embodiments, high current relays such as the Deltrol 50 A relays are provided as options. The high current relays are generally used to turn on and turn off loads with relatively high power or wattage ratings, such as a hot water heater, or other 240VAC loads that can overload the generator. Controllers for load shedding are well known in the art, such as those shown in U.S. Pat. Nos. 4,499,385,4,617,472, 6,652,330, and 6,507,164, which are incorporated herein by reference.

Referring back to FIG. 2, the load management system 100 also includes an expansion slot 236. The slot 236 can be a PCI, ISA, AGP, a ribbon cable socket, a USB socket, or the like. In one embodiment, the expansion slot 236 is a ribbon cable socket. That is, the load management system 100 can be expanded to include more loads to be controlled by inserting a ribbon cable of an expansion card into the ribbon cable socket 236. When the expansion card is added, the loads applied to the expansion card will assume lower priority than those original loads applied to the load management system 100. Generally, only one additional card is added to the load management system 100. However, in systems where more loads are to be controlled, more expansion slots can be added.

Under utility power, the load management system 100 is generally in a sleep mode. When the utility source 116 fails to supply power, and the transfer switch 120 transfers power from utility 116 to generator 112 power, an activation signal is generated. In some embodiments, the activation signal is a current signal from the generator 112. The activation signal then prompts the load management system 100 to go into an activated mode. Once in the activated mode, the load management system 100 starts to manage and to control the loads that are applied.

As described, the load management system 100 monitors both incoming generator lines 240, and tries to keep the generator loaded to less than a preset maximum amount of generator load. Although two lines are shown, other numbers of lines can also be monitored. Depending on which of the LP or the NG switch is set, the generator 112 is either operating at rated wattage, or a reduced wattage. The load management system 100 will determine the output power of the generator 112 based on the power rating switch 216 and the fuel types 220 positions. When the current transformers 224 on any generator line 240 start to see the current reaching the preset maximum current amount, the load management system 100 starts to shed loads based on a predefined priority, from a low priority to a high priority. In the embodiment shown in FIG. 4, the lowest priority is relay G (228G), and the highest priority is relay A (228A). In some other embodiments, a number of the relays 228 are dedicated to loads such as air conditioning units, and are referred to as dedicated relays. While the dedicated relays are assigned to loads such as air conditioning units, each of the rest of the relays 228 is assigned a priority lower than the dedicated relays. In this way, the rest of the relays 228 can be in a CLOSED state according to the priority assigned after the dedicated relays are in an OPENED state. Generally, the preset maximum amount is between about 60-95 percent of capacity, with 75 percent being preferred, although other percentages such as 85 percent can also be used. When the total current drawn drops to a second preset amount of rated load, the controller 208 will start to add load based on the highest priority first, followed by the second highest priority relay, until the load management system 100 reaches 75 percent load or all priority loads are back on line. The load management system 100 continues to operate this way until the generator 112 is no longer supplying power to the load management system 100, as determined by the transfer switch 120 changing to the utility position. The second preset amount is generally 60 percent, although other percentages can also be used, or once the total load percent is low enough.

When stepping loads on and off, the controller 208 waits for a preset amount of time, for example 5 seconds, before shedding or adding another prioritized load from or to the load management system 100. In this way, the load management system 100 has time to stabilize. When the controller 208 sees a large current swing in demand, the load management system 100 sheds the loads more quickly to prevent the generator 112 from overloading. Once the demand has stabilized, the loads can be added again. Specifically, the load management system 100 will start adding the applied load with the highest priority available. Thereafter, the load management system 100 waits for another preset amount of time, for example 5 seconds, and adds the next priority load. The load management system 100 will continue to add loads until all loads are added, or the preset maximum amount of rated load is reached. In some embodiments, the load management system 100 allows for only one expansion relay board. In some other embodiments, the load management system 100 does not include any expansion slot 236.

When the expansion relay board is added to the load management system 100, loads applied to the expansion relay board are automatically set to have a lower priority than those applied on the original or main board. That is, when the applied load demands more than the preset maximum amount of rated load, the load management system 100 will start to shed the loads applied on the expansion relay board first, and then shed on the main relay board second. When the total current drawn from the load management system 100 falls below the second preset amount of rated load, the loads connected to the main relay board will be connected first, and then the loads connected to the second relay board will be connected.

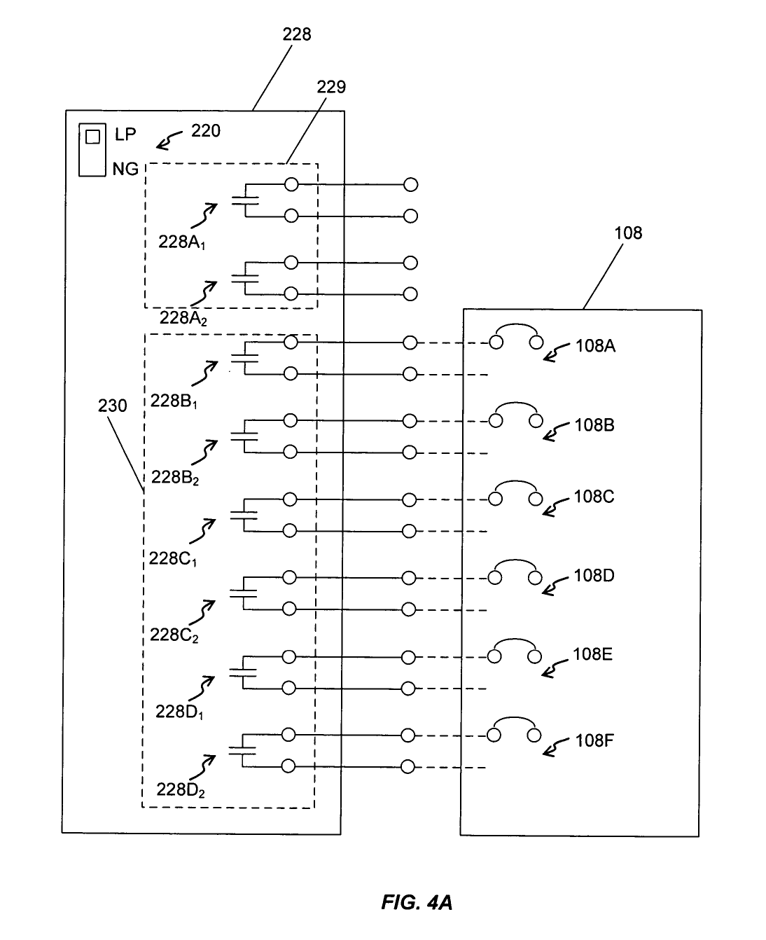

During installation, the user or installer of the load management system 100 has to decide a priority of each load in the residence 104 that is to be powered by the backup generator. FIG. 5 is an exemplary table 500 of appliances for which the user has to designate priorities. The table 500 contains a list of 240VAC electrical appliances, and a list of 120VAC electrical appliances. These lists, however, only include the types of appliances that are managed by the load management system 100. Power is typically supplied to electrical appliances with low power ratings which are considered light loads or which are to be continuously connected, such as lights, the sump pump and the furnace, and therefore, these loads generally bypass the load management system 100.

In some embodiments, one of the relays 228A-228G is selected to be a selected relay. The selected relay is generally set to search or look for a voltage source that can come from either the load management system 100, or a thermostat, or another activating voltage source. As described, the selected relay among relays 228A-228G is typically used to connect power from a power source to a load such as an air-conditioning (“A/C”) unit. If the selected relay detects an activating (voltage or current) signal from the activating voltage source, the selected relay (among relays 228A-228G) will start examining the potential power that the load can demand.

In the example that follows, without limitation, the relay 228A controls the power being supplied to the A/C unit, and the relay 228B controls the power being supplied to the hot water heater. Particularly, when the relay 228A does not detect any signal during a power outage, if the relay 228A has been opened, the relay 228A will remain open. However, when the relay 228A detects an activating (voltage or current) signal from the voltage source such as the thermostat, the system can determine if there is enough remaining power capacity to turn on or close the relay 228A to activate the A/C. If there is not enough remaining power capacity, the relay 228A will remain open regardless of the state of relay 228B. Furthermore, the load management system 100 will continuously monitor the current in the relay 228B so that the system 100 will know if opening relay 228B will allow sufficient remaining system capacity to be supplied to the A/C. If the load management system 100 determines that there is sufficient power to run the A/C, the load management system 100 will open the relay 228B to disconnect power from the hot water heater, and will close the relay 228A to activate the A/C.

More particularly, the total power that can potentially be drawn by the A/C and the hot water heater is determined. Once the total power that can potentially be drawn by the A/C and the hot water heater has been determined, the load management system 100 examines the power demand. For example, the load management system 100 can determine if the power available is enough to be supplied to the A/C through the selected relay, while keeping the other relays among relays 228B-228G closed. If the power is insufficient to run the A/C, the load management system 100 will keep the selected relay open regardless of the status of the remaining relays.

Furthermore, the load management system 100 will also be constantly monitoring the current supplied to the remaining relays among relays 228B-228G. In this way, the load management system 100 can determine if opening the remaining relays will provide sufficient power to permit the selected relay to be closed. If the load management system 100 determines that opening up the remaining relays among relays 228B-228G will permit sufficient power to be provided to the selected relay, the remaining relays are opened or turned off. When the remaining relays among relays 228B-228G are opened, the selected relay is closed or turned on to provide power to the connected load.

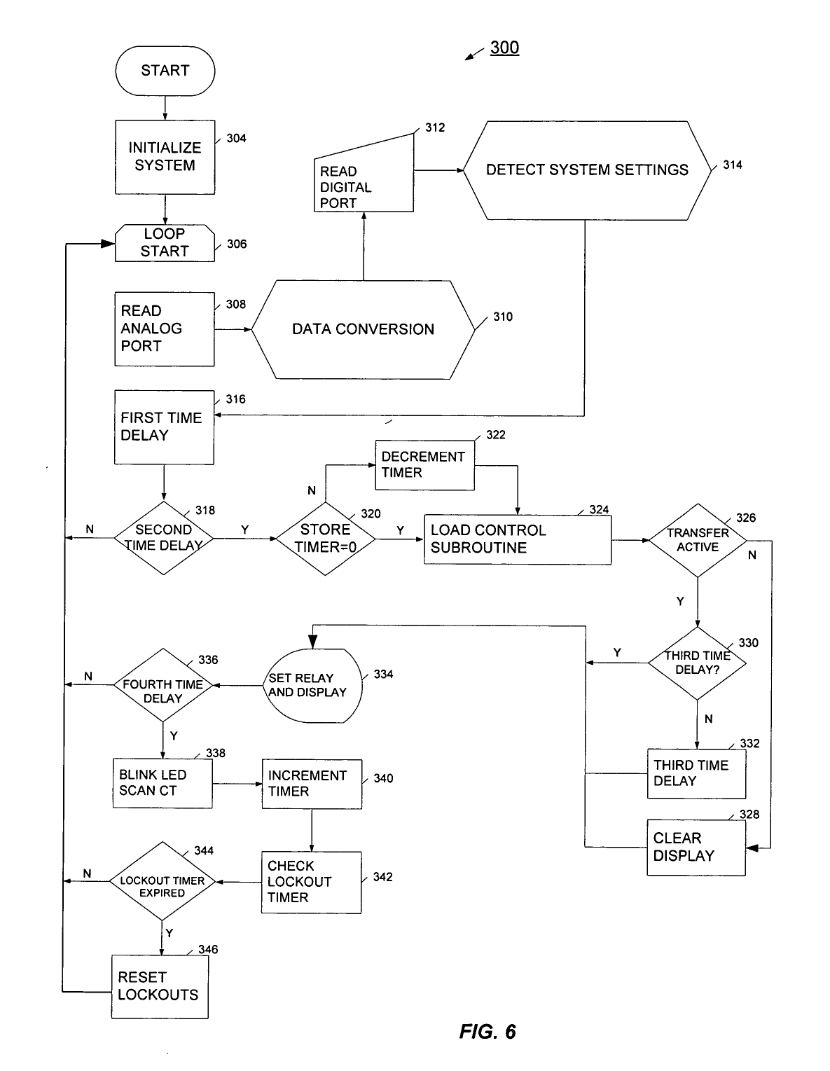

FIG. 6 is a flow chart of an exemplary load management process 300 which is part of system 100, and which may be implemented by software, firmware, or hardware. Particularly, the load management process 300 senses an electrical signal from a source such as a thermostat demanding power, as described earlier. Particularly, at block or step 304, the process 300 initializes a plurality of system operating parameters such as memory, registers, and interrupts.

Thereafter, the process 300 goes into a loop at block 306. The loop starts with reading analog information from a plurality of analog ports at block 308. The analog information includes analog voltage and current information from sources such as the generator 112, the utility source 116, and the current transformers 224. In some embodiments, a portion of the analog information can directly come from an air conditioner via a thermostat. The analog information is then digitized, averaged, compensated, and/or converted at block 310. In this way, the process 300 can determine a percentage of power drawn by each of the loads applied to the system 200. At block 312, digital information from a plurality of ports or switches is read. In some embodiments, the switches can include the power rating switch 216 and the fuel type switch 220. At block 314, the process 300 detects a second relay module that can be added to the system 200, debounces a plurality of test switches of the system 200, processes information on the transfer switch 120, sets a fuel type based on the read fuel type switches 220, sets a power rating based on the read power rating switches 216, and sets a 24 VAC status flag which can indicate an electrical signal from the thermostat.

At block or step 316, the process 300 waits for a first time delay to ensure tests are completed. The first time delay in some embodiments is 10 milliseconds. The process 300 then checks to determine if a second time delay has passed at block 318. In some embodiments, the second time delay is 500 milliseconds, and can be used to ensure the system 200 is ready to transfer power. If it is determined, at block 318, that the second time delay has not elapsed, the loop at block 306 repeats. If the second time delay has passed, the process 300 checks to determine if a store timer has been set to zero at block 320. If it is determined that the timer is not set to zero at block 320, the process 300 will decrement the store timer at block 322. Otherwise, if the store timer is set to zero, the process 300 calls or enters a load control subroutine at block 324, detailed hereinafter.

Thereafter, the process 300 checks to determine if a power transfer from the utility 116 to the generator 112 is active at block 326. If the transfer is inactive as determined at block 326, the process 300 clears a display of the system 200 at block 328. In some embodiments, the system 200 includes some displays to indicate a percentage of the generator power being supplied to the loads, and to indicate if a particular load is being powered by the generator 112. Otherwise, if the power transfer from the utility 116 to the generator 112 is active as determined at block 326, the process 300 determines if the system 200 has waited for a third time delay at block 330. In some embodiments, the third time delay is five minutes, and can be considered as a lockout timer. If the system 200 has not waited for the third time delay, the process 300 starts the third time delay, or the lockout timer in some embodiments, at block 332. Otherwise, if the process 300 has waited for the third time delay, the process 300 sets a plurality of relay switches and the display at block 334. If the load management system 100 does not include any display, only the relays are set at block 334. The process 300 then checks to determine if the system 200 has implemented a fourth time delay at block 336. In some embodiments, the fourth time delay is one second, and can be used to search for the current transformer 224. If the fourth time delay has not elapsed, the process 300 restarts at block 306. Otherwise, if the fourth time delay has elapsed as determined at block 336, the process 300 activates or blinks the display or a plurality of light-emitting-diodes (“LED's”), and continues to scan for the current transformer 224 of the system 200 at block 338. The process 300 then increments a timer at block 340. Thereafter, the process 300 reads the lockout timer at block 342, and determines if the lockout time has expired at block 344. The process 300 resets the lockout timer at block 346 if the lockout time has expired. Otherwise, the process 300 repeats block 306 if the lockout time has not expired.

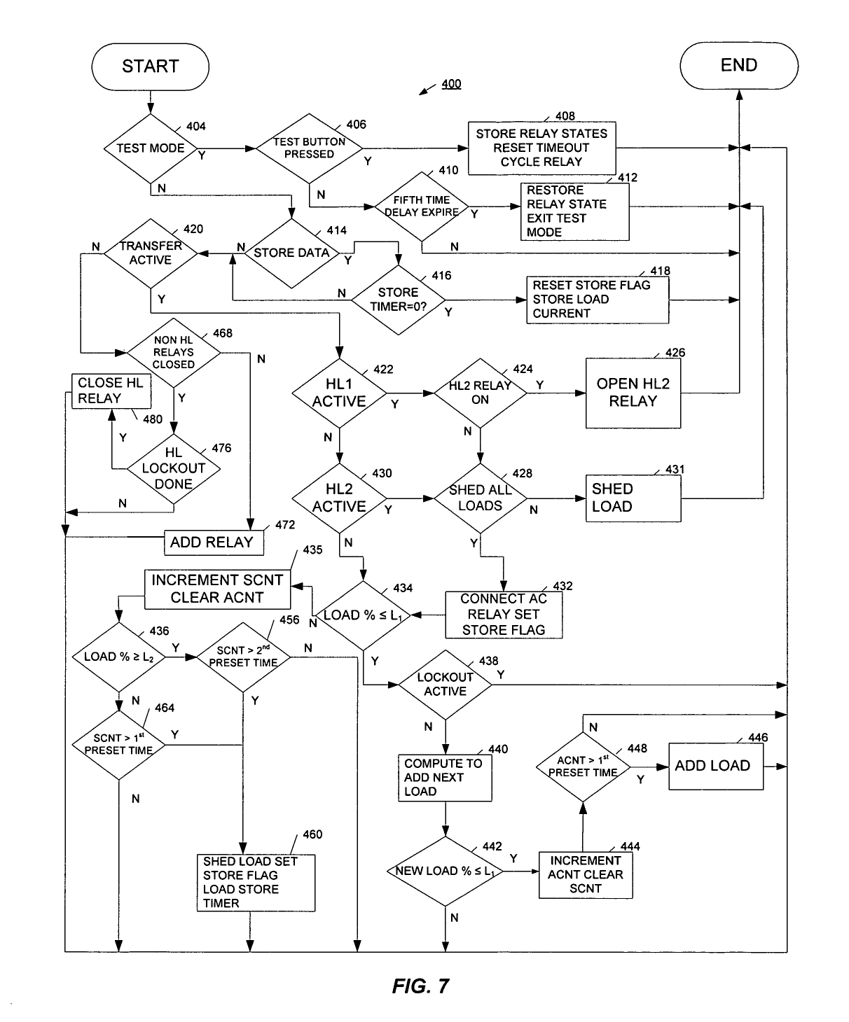

FIG. 7 is a second flow chart of an exemplary load control process 400 that is part of system 100 and that may be carried out by at least one of software, firmware, or hardware. In some embodiments, the load control process 400 can be used as part of the subroutine discussed at block 324 of FIG. 6. Once entered, the load control process 400 checks to determine if the system 200 is in a test mode at block 404. If the system 200 is in the test mode at block 404, the load control process 400 checks to determine if a test button has been touched, pressed, or pushed at block 406. If the test button has been pressed as determined at block 406, the load control process 400 stores a plurality of states of the relay switches 228, resets a timeout period, and cycles the relays 228 within the timeout period at block 408, and terminates thereafter. In some embodiments, the test button has to be repeatedly pressed to cycle through all the relays 228. If the test button has not been touched, pressed, or pushed as determined at block 406, the load control process 400 determines if a fifth time delay or the timeout period is expired at block 410. In some embodiments, the fifth time delay or the timeout period is about 30 seconds. If the fifth time delay or the timeout period is expired, the process 400 restores the states of the relay switches 228, exits the test mode at block 412, and terminates thereafter. The process 400 also terminates if the fifth time delay or the timeout period is not expired as determined in block 410.

If the system 200 is not in the test mode as determined at block 404, the process 400 checks to determine if the system 200 needs to store any data at block 414 such as information relating to the relay switches 228. If the system 200 needs to store data as determined at block 414, the process for 400 checks to determine if the store timer is set to zero at block 416. If the store timer is set to zero, the process 400 resets a store flag such that data can be stored, stores data such as the states of the relays 228 and the amount of load currents at each of the relays 228 at block 418, and terminates thereafter.

However, if the store timer is not set to zero as determined at block 416, or if no data needs to be stored as determined at block 414, the process 400 determines if the power transfer from the utility 116 to the generator 112 is active at block 420. If the power transfer is active as determined at block 420, the process 400 determines if a first high priority load (“HL1”) or a first air conditioning unit is active at block 422. If the first high priority load or the first air conditioning unit is active, the process 400 determines if the relay corresponding to a second high priority load or a second air conditioning unit is in an OPEN state at block 424. If the relay corresponding to the second high priority load or the second air conditioning unit is on or in a CLOSED state as determined at block 424, the process 400 disconnects the relay corresponding to the second high priority load or the second air conditioning unit, or ensures that the relay corresponding to the second high priority load or the second air conditioning unit is in the OPEN state at block 426. The process 400 terminates thereafter.

If the relay corresponding to the second high priority load or the second air conditioning unit is in the OPEN state, the process 400 determines if all the loads applied to the system 200 have been shed at block 428. If not all of the loads have been shed as determined at block 428, the process 400 starts a load shed process at block 430. In some embodiments, the load shed process at block 431 starts by opening a relay that has the lowest priority, detailed hereinafter.

Referring back to block 422, if the first high priority load or the first air conditioning unit is inactive as determined at block 422, the process 400 determines if the second high priority load or the second air conditioning unit is active at block 430. If the second high priority load or the second air conditioning unit is active as determined at block 430, the process 400 repeats block 428. If the process 400 determines that all the loads have been shed at block 428, the process 400 connects a first high priority load relay and a first AC relay, and sets the store flag at block 432. If the second high priority load or the second air conditioning unit is inactive, the process 400 determines if total of the applied loads is less than or equal to a predetermined load limit (L1) at block 434. In some embodiments, the predetermined load limit (L1) is about 85 percent although other limits may be used.

If the load percent is greater than the predetermined load limit (L1) as determined at block 434, the process 400 increments a SCNT counter and clears an ACNT counter at block 435, and proceeds to determine if the total of the applied loads is greater than or equal to a second predetermined load limit (L2) at block 436. In some embodiments, the second predetermined load limit (L2) is 99 percent although other limits may be used. In some embodiments, the ACNT counter stores or counts a time at which loads have been added by the system 200, whereas the SCNT counter stores or counts a time at which loads have been shed by the system 200. However, if the process 400 determines that the load percent is no greater than the predetermined load limit (L1) as determined at block 434, the process 400 determines if a lockout that inhibits the system 200 from supplying power to the relays 228 is active at block 438. If the lockout is active as determined at block 438, the process 400 terminates. If the lockout is inactive as determined at block 438, the process 400 computes or determines if the system 200 can add another load at block 440. The process 400 then checks to see if the newly computed load percent is less than or equal to the predetermined load limit (L1) at block 442. If the newly determined load percent is less than or equal to the predetermined load limit (L1) as determined at block 442, the system 200 increments an ACNT counter and clears a SCNT counter at block 444. The process 400 then determines if the ACNT counter is greater than a first preset time at block 448. In some embodiments, the first preset time is about 5 seconds. If the ACNT counter is greater than the seventh time delay as determined at block 448, the process 400 will start adding load or closing the relay 228 corresponding to the load to be added at block 446, and terminates thereafter. Otherwise, if the ACNT counter is less than the seventh time delay as determined at block 444, the process 400 terminates. However, if the newly computed load percent is greater than the predetermined load limit (L1) as determined at block 442, the process 400 terminates.

Referring back to block 436, if the load percent is at least equal to the second predetermined load limit (L2), the process 400 determines if the SCNT counter is greater than a second preset time at block 456. In some embodiments, the send preset time is about 2 seconds. If the SCNT counter is greater than the second preset time, the system 200 starts to shed loads, sets the store flag, loads the store timer at block 460, and the process 400 terminates thereafter. Otherwise, if the SCNT counter is less than the second preset time, the process 400 terminates.

If the load percent is at less than the second predetermined load limit (L2), the process 400 determines if the SCNT counter is greater than the first preset time at block 464. If the SCNT counter is greater than the first preset time, the system 200 repeats block 460. Otherwise, the process 400 terminates if the SCNT counter is less than the first preset time.

Referring back to block 420, if it is determined that the power transfer is inactive, the process 400 determines if the remaining of the relays 228 (that are not HL1 and HL2) are in a CLOSED state at block 468. If none or only some of the non-high priority load relays 228 are connected as determined at block 468, the process 400 starts to close or add a relay at block 472 according to its priority, in some embodiments. Otherwise, if all the non-high priority load relays 228 are closed as determined at block 468, the process 400 determines if the high priority loads are being locked out at block 476. If the high priority loads are not being locked out as determined at block 476, the process 400 terminates. Otherwise, if the high priority loads are being locked out as determined at block 476, the process 400 closes the high priority load relays at block 480 and terminates.

In some embodiments, the system 200 assigns a priority to each of the relays 228. For example, the system 200 can assign a plurality of loads such as air conditioning units to have the highest priorities. Similarly, the system 200 can also assign the other of the relays 228 to have a lower priority.

When the utility source 116 fails, the system 200 starts the generator 112 and the power transfer at the transfer switch 120. The system 200 then opens up all the relays 228, or ensures that all the relays 228 are in an OPEN state. The transfer switch 120 thereafter transfers power to the generator 112.

Particularly, the system 200 ensures that the relays 228 are in an OPEN state for a preset amount of time. In some embodiments, the preset amount of time can be at least five minutes. The system 200 also determines if any of the first and the second high priority loads or the first and the second air conditioning units needs to run via an electrical signal from a source such as a thermostat. If any of the first and the second high priority loads or the first and the second air conditioning units needs to run, the system 200 closes a corresponding HL1 relay (a CLOSED state) if the load percent is less than the predetermined load limit (L1) rated. However, if the first and the second high priority loads or the first and the second air conditioning units do not need to run, the system 200 closes the relays 228 corresponding to the remaining relays 228 if the load percent is less than the predetermined load limit (L1) rated. For example, if AC1 and AC2 are relays corresponding to the first and the second air conditioning units, and B1, B2, C1, C2, D1, and D2 are prioritized relays corresponding to other loads with B1 having the highest priority of the remaining relays and D2 having the lowest priority, the relays B1 and B2 are closed or are in a CLOSED state.

The system 200 then waits for a predetermined amount of time, for example five seconds, to add the loads connected to relays C1 and C2 if the load percent is still less than the predetermined load limit (L1) after the corresponding loads with higher priorities are added. Furthermore, the system 200 will wait for another predetermined amount of time to add relays D1 and D2 if the load percent is still less than the predetermined load limit (L1). However, when any of the first and the second high priority loads or the first and the second air conditioning units needs to run thereafter, the system 200 starts the load shed process (block 430 of FIG. 7) by opening up the relays D1 and D2, or by ensuring that the relays D1 and D2 are in an OPEN state. The load shed process continues to open the relays C1, and C2, and the relays B1, and B2, if needed, or until the load percent is less than the predetermined load limit (L1).

If the load percent is less than the predetermined load limit (L1) after the first and the second high priority loads or the first and the second air conditioning relays HL1 and HL2 are closed, the system 200 starts the load add process (block 446 of FIG. 7). The load add process starts by closing relays B1 and B2, followed by C1 and C2, and subsequently D1 and D2 in order, with a predetermined amount of time delay after each load addition. In some embodiments, if the loads corresponding to the relays B1 and B2 cannot be added due to the predetermined load limit, the remaining relays 228 remain in the OPEN state. When the high priority load relays are no longer needed, the relays AC1 and AC2 are opened, or are in an OPEN state. In some other embodiments, if the loads corresponding to the relays B1 and B2 cannot be added due to the predetermined load limit, the load add process looks to the relays next in priority and adds the corresponding load by closing the respective relay if the total applied load will remain below the predetermined load limit.

Various features and advantages of the invention are set forth in the following claims.

1. A load management system for residential use, the system comprising:
a first signal-responsive switch adapted to be connected to a first load;
a second signal-responsive switch adapted to be connected to a second load that has a lower priority than the first load;
a sensor adapted to sense first and second electrical signals associated with the respective first and second loads; and
a controller adapted to ensure that the second signal-responsive switch is in an OPEN state after the sensor senses that the first electrical signal exceeds a first threshold value, and that the first signal-responsive switch is in a CLOSED state after the first electrical signal exceeds a second threshold value.

2. The system of claim 1, further comprising:
a third signal-responsive switch adapted to be connected to a third load that is larger than the second load; and
a fourth signal-responsive switch adapted to be connected to a fourth load that has a lower priority than the third load.

3. The system of claim 2, wherein the first signal-responsive switch is closed before the third signal-responsive switch is closed, and the third signal-responsive switch is closed before the second and fourth signal-responsive switches are closed.

4. The system of claim 1, further comprising a timer adapted to generate a time delay after the first signal-responsive switch is opened, wherein the second signal-responsive switch is closed after the time delay.

5. The system of claim 4, wherein the time delay is between 2 to 600 seconds.

6. The system of claim 1, wherein the first threshold value equals the second first threshold value.

7. The system of claim 1, wherein the first and second electrical signals are at least one of a voltage, current, and power signals.

8. The system of claim 1, wherein the first threshold value is between 60 to 95 percent.

9. The system of claim 1, further comprising a third signal-responsive switch adapted to be connected to a third load that is smaller than the second load, and the second signal-responsive switch is closed before the third signal-responsive switch is closed.

10. The system of claim 1, wherein the first and second signal-responsive switches comprise relays.

11. The system of claim 1, wherein the sensor comprises at least one current transformer.

12. The system of claim 1, further comprising a generator operable to supply power to the first load when the first signal-responsive switch is closed.

13. The system of claim 1, wherein the controller is adapted to keep the second signal-responsive switch in an OPEN state if the second signal-responsive switch is in an OPEN state when the first electrical signal exceeds the first threshold value, and to open the second signal-responsive switch if the second signal-responsive switch is in a CLOSED state when the first electrical signal exceeds the first threshold value; and
wherein the controller is adapted to keep the first signal-responsive switch in a CLOSED state if the first signal-responsive switch is in a CLOSED state when the first electrical signal exceeds the second threshold value, and to close the first signal-responsive switch if the first signal-responsive switch is in an OPEN state when the first electrical signal exceeds the second threshold value.

14. The system of claim 1, further comprising a third signal-responsive switch adapted to be connected to a third load that has a lower priority than the second load, wherein the controller is adapted to ensure that the second signal-responsive switch is in a CLOSED state before the third signal-responsive switch is in a CLOSED state after the first electrical signal drops below the first threshold value, and that the first signal-responsive switch is in an OPEN state after the first electrical signal drops below the second threshold value.

15. The system of claim 1, wherein the controller is further adapted to ensure that the second signal-responsive switch is in a CLOSED state after the first electrical signal drops below the first threshold value, and that the first signal-responsive switch is in an OPEN state after the first electrical signal drops below the second threshold value.

16. The system of claim 1, wherein the controller further comprises
a first comparator adapted to determine if the first electrical signal exceeds the first threshold value; and
a second comparator adapted to determine if the first electrical signal exceeds the second threshold value.

17. The system of claim 1, wherein the controller further comprises a memory adapted to record a first value of the first electrical signal before the second signal-responsive switch is open.

18. A method of managing loads for residential use, the method comprising:
connecting a first signal-responsive switch to a first load;
connecting a second signal-responsive switch to a second load that has a lower priority than the first load;
sensing first and second electrical signals from the respective first and second loads; and
ensuring the second signal-responsive switch is open after the first electrical signal exceeds a first threshold value, and the first signal-responsive switch is closed after the first electrical signal exceeds a second threshold value.

19. The method of claim 18, further comprising:
connecting a third signal-responsive switch to a third load that has a higher priority than the second load; and
connecting a fourth signal-responsive switch to a fourth load that has a lower priority than the third load.

20. The method of claim 19, further comprising:
closing the first signal-responsive switch before the third signal-responsive switch; and
closing the third signal-responsive switch before the second and fourth signal-responsive switches.

21. The method of claim 18, further comprising closing the second signal-responsive switch after a time delay and after opening the first signal-responsive switch.

22. The method of claim 21, further comprising setting the time delay to between 2 to 600 seconds.

23. The method of claim 18, further comprising equating the first threshold value the second first threshold value.

24. The method of claim 18, wherein the first and second electrical signals comprise at least one of a voltage, current, and power signals.

25. The method of claim 18, wherein setting the first threshold value to between 60 to 95 percent.

26. The method of claim 18, further comprising:
connecting a third signal-responsive switch to a third load that has a lower priority than the second load; and
closing the second signal-responsive switch before the third signal-responsive switch.

27. The method of claim 18, wherein the first and second signal-responsive switches comprise relays.

28. The method of claim 18, wherein sensing the first and second electrical signals comprises sensing with at least one current transformer.

29. The method of claim 18, further comprising:
generating power at a generator; and
supplying the power from the generator to the first load when the first signal-responsive switch is closed.

30. The method of claim 18, wherein ensuring the second signal-responsive switch is open and the first signal-responsive switch is closed further comprises:
keeping the second signal-responsive switch open when the second signal-responsive switch is open after the first electrical signal exceeds the first threshold value;
opening the second signal-responsive switch when the second signal-responsive switch is closed after the first electrical signal exceeds the first threshold value;
keeping the first signal-responsive switch closed when the first signal-responsive switch is closed after the first electrical signal exceeds the second threshold value; and
closing the first signal-responsive switch when the first signal-responsive switch is open after the first electrical signal exceeds the second threshold value.

31. The method of claim 18, further comprising:
connecting a third signal-responsive switch to a third load that has a lower priority than the second load; and
ensuring the second signal-responsive switch is closed before the third signal-responsive switch after the first electrical signal drops below the first threshold value, and the first signal-responsive switch is opened after the first electrical signal drops below the second threshold value.

32. The method of claim 18, further comprising ensuring the second signal-responsive switch is closed after the first electrical signal drops below the first threshold value, and the first signal-responsive switch is open after the first electrical signal drops below the second threshold value.

33. The method of claim 18, further comprising:
determining if the first electrical signal exceeds the first threshold value; and
determining if the first electrical signal exceeds the second threshold value.

34. The method of claim 18, further comprising recording a first value of the first electrical signal before the second signal-responsive switch is open.
